(19) United States
(12) Patent Application Publication
(10) Pub. No.: US 2018/0169512 A1
(43) Pub. Date: Jun. 21, 2018

(54) MEMORY STIMULATING BOARD GAME SYSTEM AND METHOD

(71) Applicant: Tracie Taylor, Hot Springs, AR (US)

(72) Inventor: Tracie Taylor, Hot Springs, AR (US)

(21) Appl. No.: 15/795,766

(22) Filed: Oct. 27, 2017

Related U.S. Application Data
(60) Provisional application No. 62/435,691, filed on Dec. 16, 2016.

(51) Int. Cl. A63F 3/04; G09B 19/22; A63F 9/04; A63F 11/00; A63F 3/00

(52) U.S. Cl. CPC A63F 3/0478; G09B 19/22; A63F 9/04; A63F 11/0074; A63F 11/00; A63F 3/00697; A63F 2003/0076; A63F 2011/0083; A63F 2250/1068; A63F 2003/00943; A63F 2003/00018; A63F 2003/0489; A63F 3/00006

(57) ABSTRACT

An apparatus for providing entertainment having a planar surface with a plurality of areas located in a center of the planar surface; a predetermined number of spaces located about a perimeter of the planar surface; a predetermined number of game cards configured to be placeable on the plurality of areas of the planar surface; a plurality of chips configured to be played on the planar surface; a plurality of player-pieces configured to be moved about the perimeter of the planar surface; a dice member used to determine an order of play among a plurality of players; and a mechanism for measuring an amount of time. The apparatus for providing entertainment is useful for providing entertainment when played.

### CROSS-REFERENCE TO RELATED APPLICATION(S)

The present application is related to and claims priority to U.S. Provisional Patent Application No. 62/435,691 filed Dec. 16, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of entertainment and more specifically relates to multi-player board games.

### RELATED ART

Many people enjoy playing board games. A game is structured form of play, usually undertaken for enjoyment and sometimes used as an educational tool. Key components of games are goals, rules, challenge, and interaction. Games generally involve mental or physical stimulation, sometimes simultaneously. Some games can be played individually, or in a group, depending on the type of game.

U.S. Pat. No. 4,089,527 to Barry B. Roth relates to a board game apparatus. The described board game apparatus includes a game that is usually played by two to four persons and requires memorization, generally by association, of certain predetermined facts to be successful at winning. The game apparatus comprises a board which defines a playing field having marked squares defining a continuous path or course extending about the board, a plurality of numbered memory cards or a memory list, four colored playing pieces, a clock, dice, a deck of luck cards and a number of marker cubes. The board squares include numbered squares which carry written or graphic indicia and which correspond numerically to the memory cards, luck squares which are associated with the luck cards and opportunity squares. When a player lands on a square, the square is then his and is marked by one of his marker cubes. The opponents are given one minute to memorize the corresponding memory card, which provides assorted and variable information such as a state and its capitol and sometimes an illustration of the information. The information to be recalled may be memorized by association with indicia on the corresponding number square or may be memorized by association with the illustration (where provided) on the memory card. If an opponent thereafter lands in the controlled square the player who controls it can request that the opponent recall the information on the corresponding memory card and also one other memory card corresponding to another square controlled by the player. When memory cards have on them illustrations, a player asked to recall the card is allowed to see the illustration. Failure to recall on the part of any player requires that player to restart.

### SUMMARY OF THE INVENTION

In view of the foregoing disadvantages inherent in the known multi-player board games art, the present disclosure provides a novel memory stimulating board game system and method. The general purpose of the present disclosure, which will be described subsequently in greater detail, is to provide a novel entertaining memory stimulating board game system and method.

An apparatus for providing entertainment is disclosed herein. The apparatus for providing entertainment includes a planar surface, a predetermined number of spaces, a predetermined number of game cards, a plurality of chips, a plurality of player-pieces, a dice member, and a mechanism for measuring an amount of time.

An apparatus is disclosed for providing entertainment comprising; a planar surface, the planar surface may have a plurality of areas located in a center of the planar surface; a predetermined number of spaces, the predetermined number of spaces may be located about a perimeter of the planar surface; a predetermined number of game cards, the predetermined number of game cards may be configured to be placeable on the plurality of areas of the planar surface; a plurality of chips, the plurality of chips may be configured to be played on the planar surface; a plurality of player-pieces, the plurality of player-pieces may be configured to be moved about the perimeter of the planar surface; a dice member, the dice member may be used to determine an order of play among a plurality of players; and a mechanism for measuring an amount of time; wherein the apparatus may be configured to provide entertainment when played.

The dice member may be configured to determine an exact number of spaces to be moved by each of the plurality of players after a roll of the dice member. Each of the plurality of areas may be rectangular in shape, and may be colored. There may be at least four areas within the plurality of areas. The predetermined number of game cards may include a predetermined number of instruction game cards. Each of the predetermined number of instruction game cards includes instructive means for instructing one of the plurality of players to mimic an action or sound listed on each of the predetermined number of instruction game cards. The action or sound listed on the instruction game card may be a command and alternately, a gesture.

The plurality of player-pieces may be at least four player-pieces. Each of the plurality of player-piece(s) may comprise a different color. The planar surface may be a playing surface and alternately, a game board. The plurality of chips may be circular in shape and alternately, colored. The mechanism for measuring an amount of time may comprise an hour-glass.

According to another embodiment, a method of playing a board game is also disclosed herein. The method of playing a board game includes providing a planar surface, rolling the die member to determine which player takes a first turn, rolling the die member by a first player, moving one of the plurality of player-pieces an exact number of the spaces as determined by the die member, selecting one of the predetermined number of game cards, mimicking an action or sound listed on one of the predetermined number of game cards, and mimicking a previous action or sound of one of the plurality of players.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a memory stimulating board game system and method, constructed and operative according to the teachings of the present disclosure.

FIG. 1 is a perspective view of the apparatus for providing entertainment during an ‘in-use’ condition, according to an embodiment of the disclosure.

FIG. 2 is a close-up view of the apparatus for providing entertainment of FIG. 1, according to an embodiment of the present disclosure.

FIG. 3 is a perspective view of the apparatus for providing entertainment of FIG. 1, according to an embodiment of the present disclosure.

FIG. 4 is a perspective view of the apparatus for providing entertainment of FIG. 1, according to an embodiment of the present disclosure.

FIG. 5 is a perspective view of the apparatus for providing entertainment of FIG. 1, according to an embodiment of the present disclosure.

FIG. 6 is a flow diagram illustrating a method of playing a board game, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to multi-player board games and more particularly to a memory stimulating board game system and method as used to improve entertainment derived from multi-player board games.

Generally, the game as disclosed has a time keeper responsible for flipping a timer when a card is drawn, and watches for a player to finish his/her turn before time is up. Each player chooses a colored player piece, which is placed on start along with a specific color set of chips to begin gameplay. All players must roll the dice in order to determine who goes first with the highest roll being selected. When the first player rolls, he/she moves forward the number indicated on the dice. Play progresses clockwise on the board. Once the first player rolls, the player moves the appropriate number of spaces, and a card is chosen based on the color of the space where the player piece lands. The action or sound on the card must then be mimicked by the player. The next player must roll the dice, choose a card, and then mimic the actions or sounds of the previous player and their own card. Subsequent players must mimic each previous action or sound in order to progress through the game. Should a player forget the action or sound of the previous player, a chip is added to their player piece. Once five chips have been added to the player piece, the player is eliminated from the game.

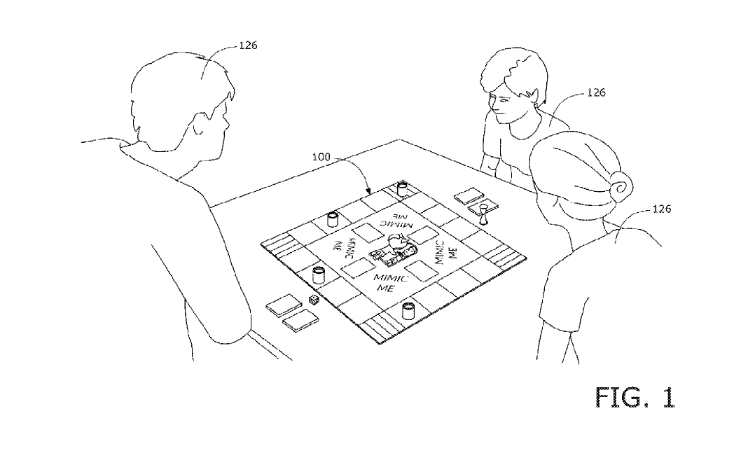

Referring now more specifically to the drawings by numerals of reference, there is shown in FIGS. 1-4, various views of an apparatus for providing entertainment 100.

FIG. 1 shows an apparatus for providing entertainment 100 during an ‘in-use’ condition, according to an embodiment of the present disclosure. Here, the apparatus for providing entertainment 100 may be beneficial for use by a user 126 to provide entertainment to individuals in a group. As illustrated, the apparatus for providing entertainment 100 may include a planar surface 110, a predetermined number of spaces 114, a predetermined number of game cards 118, a plurality of chips 120, a plurality of player-pieces 122, a dice member 124, and a mechanism for measuring an amount of time 128.

An apparatus for providing entertainment 100 comprising: a planar surface 110, the planar surface 110 may have a plurality of areas 112 located in a center of the planar surface 100. The apparatus may have a predetermined number of spaces 114, and the predetermined number of spaces 114 located about a perimeter 116 of the planar surface 100. A predetermined number of game cards 118 may be configured to be placed on the plurality of areas 112 of the planar surface 100. A plurality of chips 120 may be configured to be played on the planar surface 100. A plurality of player-pieces 122 may be configured to be moved about the perimeter 116 of the planar surface 110. A dice member 124 may be used to determine an order of play among a plurality of players 126.

The dice member 124 may be configured to determine an exact number of spaces to be moved by each of the plurality of players 126 after a roll of the dice member 124. Each of the plurality of areas 112 may be rectangular in shape and alternately, may be colored. The plurality of areas 112 may be at least four of the areas. The predetermined number of game cards 118 includes a predetermined number of instruction game cards that may include instruction means for instructing one of the plurality of players 126 to mimic an action or sound listed on each of the predetermined number of instruction game cards. The action or sound may be a gesture, and alternately a command. The plurality of player-pieces 122 may be at least four of the player-pieces and each of the plurality of player-pieces 122 may comprise a different color. The planar surface 110 may be a playing surface and alternately, a game board. The plurality of chips 120 may be circular in shape and alternately, colored; and wherein the mechanism for measuring an amount of time 128 may include an hour-glass.

According to one embodiment, the apparatus for providing entertainment 100 may be arranged as a kit 105. In particular, the apparatus for providing entertainment 100 may further include a set of instructions 107. The instructions 107 may detail functional relationships in relation to the structure of the apparatus for providing entertainment 100 such that apparatus for providing entertainment 100 can be used, maintained, or the like, in a preferred manner.

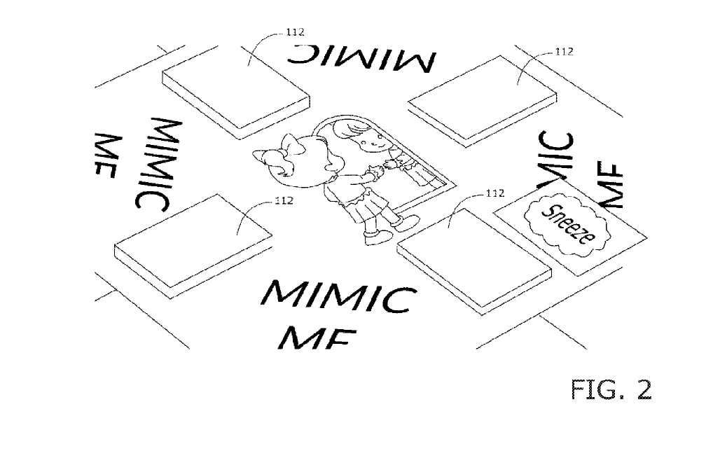

FIG. 2 shows the apparatus for providing entertainment 100 of FIG. 1, according to an embodiment of the present disclosure. As above, the apparatus for providing entertainment 100 may include a planar surface 110, a predetermined number of spaces 114, a predetermined number of game cards 118, a plurality of chips 120, a plurality of player-pieces 122, a dice member 124, and a mechanism for measuring an amount of time 128. Planar surface 110 may include a plurality of areas 112 located in a center of the planar surface 110, and a predetermined number of game cards 118 configured to be placeable on the plurality of areas 112 of the planar surface 110.

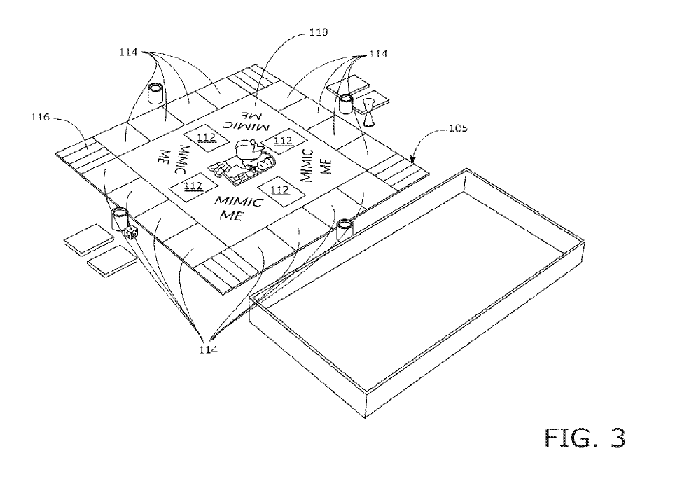

FIG. 3 is a perspective view of the apparatus for providing entertainment 100 of FIG. 1, according to an embodiment of the present disclosure. The dice member 124 is configured to determine an exact number of spaces to be moved by each of the plurality of players 126 after a roll of the dice member 124. The plurality of player-pieces 122 is at least four of the player-pieces; wherein each of the plurality of player-pieces 122 comprises a different color. The mechanism for measuring an amount of time 128 may include an hour-glass. Each of the plurality of areas 112 may be rectangular in shape; and further each of the plurality of areas 112 may be colored.

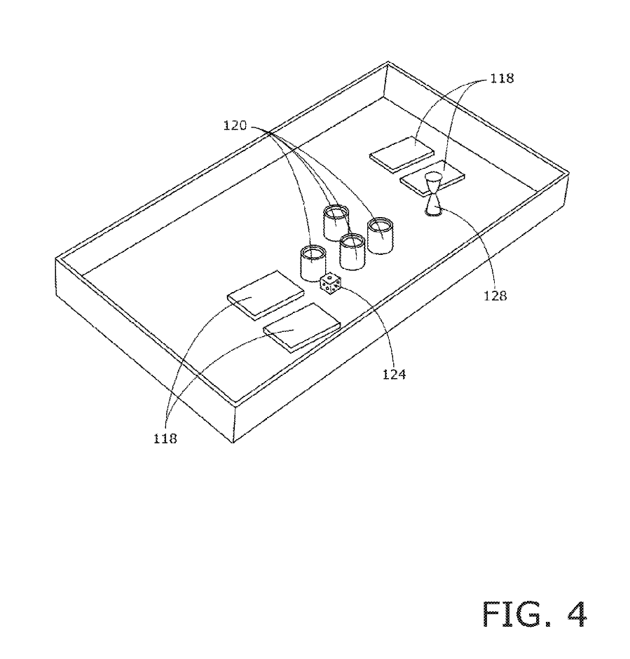

FIG. 4 is a perspective view of the apparatus for providing entertainment 100 of FIG. 1, according to an embodiment of the present disclosure. The predetermined number of game cards 118 includes a predetermined number of instruction game cards. Each of the predetermined number of instruction game cards may include instruction means for instructing one of the plurality of players 126 to mimic an action or sound listed on each of the predetermined number of instruction game cards.

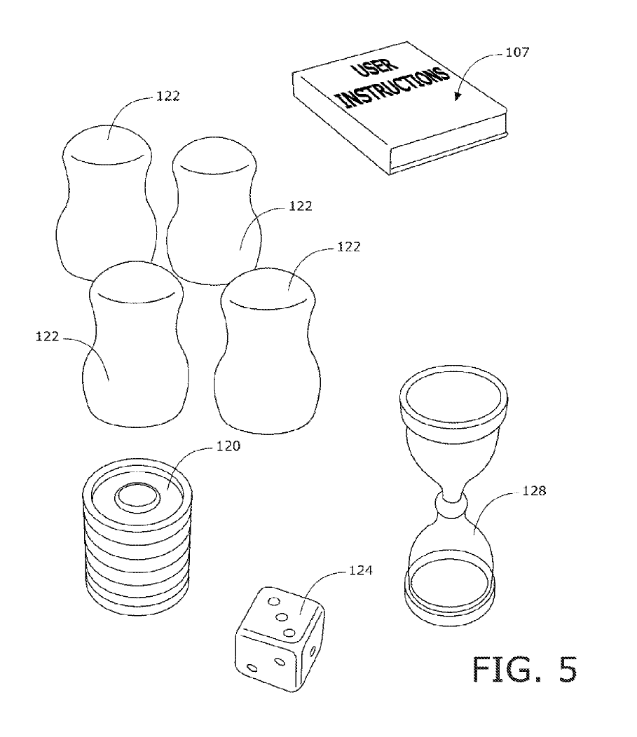

FIG. 5 is a perspective view of the apparatus for providing entertainment 100 of FIG. 1, according to an embodiment of the present disclosure. The dice member 124 may be configured to determine an exact number of spaces to be moved by each of the plurality of players 126 after a roll of the dice member 124. The mechanism for measuring an amount of time 128 may include an hour-glass. The plurality of player-pieces 122 may be at least four of the player-pieces and each of the plurality of player-pieces 122 may comprise a different color. The plurality of chips 120 are circular in shape and alternately, may be colored.

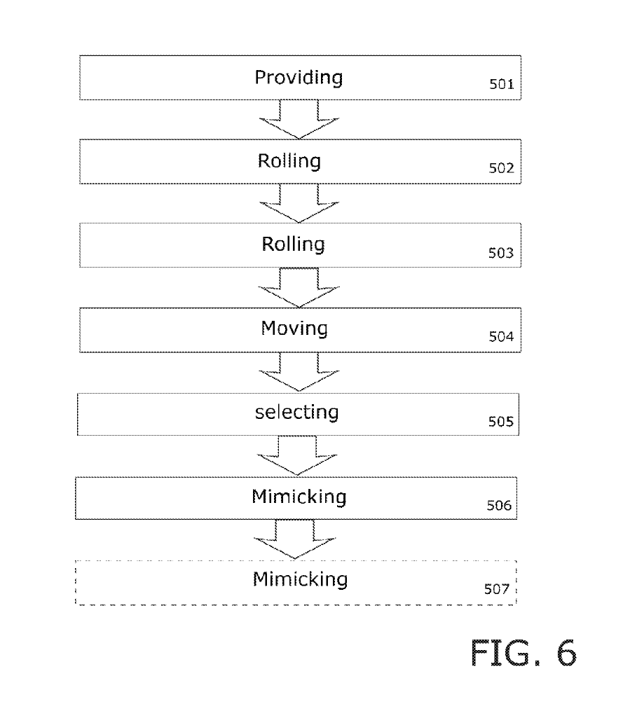

FIG. 6 is a flow diagram illustrating a method of playing 500 a board game, according to an embodiment of the present disclosure. In particular, the method for playing 500 a board game may include one or more components or features of the apparatus for providing entertainment 100 as described above. As illustrated, the method for playing a board game 500 may include the steps of: step one 501, providing a planar surface; step two 502, rolling the die member to determine which player takes a first turn; step three 503, rolling the die member by a first player; step four 504, moving one of the plurality of player-pieces an exact number of the spaces as determined by the die member; step five 505, selecting one of the predetermined number of game cards, step six 506, mimicking an action or sound listed on one of the predetermined number of game cards; and step seven 507, mimicking a previous action or sound of one of the plurality of players.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for playing a board game, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

what is claimed is new and desired to be protected by Letters Patent is set forth in the appended claims:

1. An apparatus for providing entertainment, the apparatus comprising:
a planar surface, the planar surface having a plurality of areas located in a center of the planar surface;
a predetermined number of spaces, the predetermined number of spaces located about a perimeter of the planar surface;
a predetermined number of game cards, the predetermined number of game cards configured to be placeable on the plurality of areas of the planar surface;
a plurality of chips, the plurality of chips configured to be played on the planar surface;
a plurality of player-pieces, the plurality of player-pieces configured to be moved about the perimeter of the planar surface;
a dice member, the dice member used to determine an order of play among a plurality of players;
a mechanism for measuring an amount of time; and
wherein the apparatus is configured to provide the entertainment when played.

2. The apparatus of claim 1, wherein the dice member is configured to determine an exact number of spaces to be moved by each of the plurality of players after a roll of the dice member.

3. The apparatus of claim 1, wherein each of the plurality of areas is rectangular in shape.

4. The apparatus of claim 1, wherein each of the plurality of areas is colored.

5. The apparatus of claim 1, wherein the plurality of areas is at least four of the areas.

6. The apparatus of claim 1, wherein the predetermined number of game cards includes a predetermined number of instruction game cards.

7. The apparatus of claim 6, wherein each of the predetermined number of instruction game cards includes instructive means for instructing one of the plurality of players to mimic an action listed on each of the predetermined number of instruction game cards.

8. The apparatus of claim 7, wherein the action is a gesture.

9. The apparatus of claim 7, wherein the action is a command.

10. The apparatus of claim 1, wherein the plurality of player-pieces is at least four of the player-pieces.

11. The apparatus of claim 1, wherein each of the plurality of player-piece(s) comprises a different color.

12. The apparatus of claim 1, wherein the planar surface is a playing surface.

13. The apparatus of claim 1, wherein the planar surface is a game board.

14. The apparatus of claim 1, wherein the plurality of chips is circular in shape.

15. The apparatus of claim 14, wherein the plurality of chips is colored.

16. The apparatus of claim 1, wherein the mechanism for measuring an amount of time comprises an hour-glass.

17. An apparatus for providing entertainment, the apparatus comprising:
a planar surface, the planar surface having a plurality of areas located in a center of the planar surface;
a predetermined number of spaces, the predetermined number of spaces located about a perimeter of the planar surface;
a predetermined number of game cards, the predetermined number of game cards configured to be placed on the plurality of areas of the planar surface;
a plurality of chips, the plurality of chips configured to be played on the planar surface;
a plurality of player-pieces, the plurality of player-pieces configured to be moved about the perimeter of the planar surface;
a dice member, the dice member used to determine an order of play among a plurality of players;
a mechanism for measuring an amount of time;
wherein the apparatus is configured to provide entertainment;
wherein the dice member is configured to determine an exact number of the spaces to be moved by each of the plurality of players after a roll of the dice member;
wherein each of the plurality of areas is rectangular in shape;
wherein each of the plurality of areas is colored;
wherein the plurality of areas is at least four of the areas;
wherein the predetermined number of game cards includes a predetermined number of instruction game cards;
wherein each of the predetermined number of instruction game cards includes instruction means for instructing one of the plurality of players to mimic an action listed on each of the predetermined number of instruction game cards;
wherein the action is a gesture, and alternately a command;
wherein each of the predetermined number of instruction game cards includes instruction means for instructing one of the plurality of players to alternately mimic a sound listed on each of the predetermined number of instruction game cards;
wherein the plurality of player-pieces is at least four of the player-pieces;
wherein each of the plurality of player-pieces comprises a different color;
wherein the planar surface is a playing surface;
wherein the planar surface is a game board;
wherein the plurality of chips is circular in shape;
wherein the plurality of chips is colored; and
wherein the mechanism for measuring an amount of time includes an hour-glass.

18. The apparatus of claim 17, further comprising set of instructions; and
wherein the apparatus is arranged as a kit.

19. A method of playing a board game, the method comprising:
providing a planar surface, the planar surface having a plurality of areas located in a center of the planar surface; a predetermined number of spaces, the predetermined number of spaces located about a perimeter of the planar surface; a predetermined number of game cards, the predetermined number of game cards configured to be placed on the plurality of areas of the planar surface; a plurality of chips, the plurality of chips configured to be played on the planar surface; a plurality of player-pieces, the plurality of player-pieces configured to be moved about the perimeter of the planar surface; a dice member, the dice member used to determine an order of play among a plurality of players; a mechanism for measuring an amount of time;
rolling the dice member to determine which player takes a first turn;
rolling the dice member by a first player;
moving one of the plurality of player-pieces an exact number of the spaces as determined by the dice member;
selecting one of the predetermined number of game cards; and
mimicking an action listed on one of the predetermined number of game cards.

20. The method of claim 19, wherein the method further includes the step of mimicking a previous action of one of the plurality of players.
